(19) United States
(12) Patent Application Publication
(10) Pub. No.: US 2003/0028799 A1
(43) Pub. Date: Feb. 6, 2003

(54) Processes and systems for secure access to information resources using computer hardware

(76) Inventor: Robert H. Cordella JR., Oakton, VA (US)

Correspondence Address: DOWELL & DOWELL PC, SUITE 309, 1215 JEFFERSON DAVIS HIGHWAY, ARLINGTON, VA, 22202

(21) Appl. No.: 09/917,620

(22) Filed: Jul. 31, 2001

(51) Int. Cl. G06F 11/30; G06F 12/14

(52) U.S. Cl. 713/200

(57) ABSTRACT

A method and system for enabling safe external connectivity for a workstation, by using multiple mass-storage devices, each of which defines a separate physical machine within the workstation, such that an individual separate machine of the workstation may access external information resources (such as the Internet), without contamination (from such external resources) of other separate machines of the workstation. Individual mass-storage devices are selected by a switch function which insures that, at most, one mass-storage device is selected and active at any time. The switch function also resets the workstation, as a step in the mass-storage device selection process. This insures there is no information signal transfer (thus no contamination) from any separate machine to another.

### BACKGROUND OF THE INVENTION

1. Field of the Invention

This invention relates to methods and devices for the safe and secure operation of host information systems which must exchange information with other information systems and devices, such as in cyberspace and, where such external systems may be corrupted in some manner, utilizing system architecture and data signal isolation as opposed to conventional software based firewalls to receive and process incoming information signals from the external systems, while preventing the transfer of corrupted information signals to the host systems. The invention provides for screening of outgoing information signals from the host systems to prevent unauthorized information exchange and for permitting secure updating of host systems files with information before updated files are returned to the host systems. The invention also provides a self decontamination capability that removes any corrupted information signals, and confines & repairs any damage that such signals may cause.

2. Description of the Prior Art

The field of information-system security (InfoSec) technology and practice to date has focused on controlling human user access to computer system resources, and preventing hostile, clandestine computer programs, such as computer viruses, from corrupting a computer system. The advent of the Internet and personal computers brought new challenges to the InfoSec field, particularly because in networks, other machines, not human users, were the entities that primarily accessed a computer system. Old, pre-network, password usage and similar software authentication methods only offered a modicum of security control at “authorized user” entry points of a network. Intruders could bypass these methods as they do in today's Internet and tap or hack (i.e. the term hackers) into the communications segment of a computer network and execute any form of mischief or cause disruption. This is the core of today's Internet security problem, wherein intruders can disrupt nearly all forms of Internet activity, from disabling web sites and compromising message traffic, to falsifying identity. The conventional InfoSec problems of unauthorized user access, incorrect operation, and system malfunction remain, in addition to today's network oriented security problems.

Various schemes of varying degrees of complexity and convolution have been devised to provide needed security. Examples of two of the latest of such schemes are U.S. Pat. Nos. 5,623,601 to Vu, and 5,632,011 to Landfield, et al. The methods taught are implemented as software computer programs, which operate with or as a standard operating system software package. Assumed in the methods are the correct implementation and operation of these software packages, and the operating system (i.e. control software) with which it must operate. Here, “correct operation” also includes InfoSec correctness which means no compromise to a hosting system is precipitated by the operation of such software. Proving or verifying such assertions as software correctness, or software operational integrity remains a major barrier in InfoSec technology, as well as in computer science and engineering in general. Software verification is a formidable undertaking. Finally, software (i.e. computer programs) is vulnerable to compromise by other computer programs, which may include viruses. Software attack and corruption, whether e-mail packages, protocol modules, operating systems, macro services such as OPEN commands, etc. is the realm of the system/network intruder (the Hacker). The ideal InfoSec tool should not be software dependant.

Today's InfoSec tools such as the above cited references implement, in software, a type of gateway function. The term firewall is often used. A gateway is a computer that connects two different networks together. A firewall is a gateway with the additional constraints and properties that all inter-network traffic must pass through it, whereby all unauthorized (according to some rule-set or security policy) traffic is prevented from passage. The firewall must operate correctly and be free from compromise. To further compound this difficulty, firewalls are filters. As such they must allow selected external traffic to pass through to the system or network being protected, especially if useful information exchange between the systems and networks separated by the firewall, is to take place. Firewalls have no way to filter out hostile traffic, without prior knowledge of such traffic. Also, service packages, such as e-mail, containing corrupted command macro programs (e.g. macro viruses) are impervious to firewalls. Possible legitimate bit configurations in command fields of standard message traffic passing through a firewall could trigger disruptive events, when entering a protected system or network. Firewalls, acting as an address translation proxy for an inside/protected system or network, can protect that system or network from exposure, to an external system or network, of its internal and critical address information. Again, one assumes (usually, without rigorous basis) correctness of the proxy software function.

Other attempts to establish a secure internetworking capability have resulted in hard-disk drive (HDD) controllers that attempt to segment an HDD by use of separate FAT's (file allocation tables) for the different segments of the HDD. These attempts are software based, relying heavily on the integrity of the hosting operating system, but are often presented as hardware solutions. These type systems are, in effect, extensions of the host operating system (e.g. Windows, etc.) Of the host workstation. As such, these HDD segmenting systems are vulnerable to compromise (e.g. viruses, hackers, etc.), as is the host operating system. These devices create “virtual” machines on a workstation. Usually two such “virtual” machines are created. One is for internal use. The other is for external (e.g. Internet) access. These virtual machines are separated by the software methods (e.g. separate FAT's for each segment of the HDD unit) mentioned above. As the host operating system software is corrupted, so also is the virtual machine handling software of these methods.

The fundamental guiding principle is that software compromise (e.g. from viruses, hackers, and the like), cannot be effectively countered by other software. One cannot fight bad software with other software and expect to win.

The A/B switch architecture is a small, but not generally cost effective, step in the right direction. Generically, using an A/B switch architecture involves the normal mouse/keyboard/monitor hooked to a switch (an A/B switch) which permits time-serial connectivity to one of two system-units/towers of a workstation. Thus, true physical separation is achieved, and no direct, information signal transfer (thus no contamination) passes from one system-unit to another. The trade-off is that two or more system-units are required per workstation. Since the majority of workstation costs is embedded in the system-unit, the A/B switch architecture is arguably a non-cost effective solution to secure inter-networking.

Firewalls, anti-virus software, file control schemes, and the like, are fundamentally software InfoSec tools. One cannot effectively fight hostile software with other software. More comprehensive protection of information systems and networks is needed, whereby such protection is easily verifiable, cost-effective, and does not require “apriori knowledge” to successfully execute its InfoSec function, and is software independent.

Ideally, a method and/or system that integrates the A/B switch type architecture into a single workstation's system-unit, is desired.

### SUMMARY OF THE INVENTION

The present invention is directed to the use of a multiple machine switch which controls the activation and deactivation of mass-storage units and embedded-computer type systems, connected to a workstation. The invention comprises a switching process, the connectivity (to a workstation) of mass-storage and embedded-computer type systems, and the method of operating a workstation enhanced with embedded type systems.

The terms unit and device are used interchangeably, throughout this document. However, where noted, the term “unit” will include several (a multiplicity of) “devices”. The term “domain” is defined (herein) as all resources under control of a single computer system.

The invention is a method and system to permit a workstation (i.e. personal computer) to safely connect to different external resources. Each mass-storage unit (and embedded type computer system) defines a (physically separated) separate machine within the workstation. The workstation thus contains a set of separate machines. The embedded type computer systems are hereafter (in the course of this document) referred to as computer-system-based mass-storage units.

The invention utilizes the fact that a workstation's key components can function as different machines, by controlling the software on its HDD. Therefore, having multiple, independent, HDD units operated sequentially in time, physically separated, functionally separated by a workstation shutdown & restart process, enables the user to separate operations and functions, as fits a particular application. The intervening shutdown and restart process eliminates sharing of information between HDD defined sequences. Independent HDD use is achieved via hardware control, by the user, through a manually operated exclusive-OR (XOR) type switch. The switch is used to select the, user designated, HDD unit. Each HDD unit defines a physically separate machine. The workstation thus has a set of separate machines that are physically separated, and user activated, such that (at most) only one separate machine is active at any time.

A workstation with a minimum of two HDD units can provide that workstation with a public separate machine, and a private/internal separate machine. The public separate machine is connected to the rest of the world (ROTW). This public separate machine, when combined with a disk image of its HDD unit's pristine software configuration, provides a domain into which viruses, hackers, and like contamination may enter, be therein confined, and later removed via workstation reboot combined with the HDD unit's image reload.

The invention has several embodiments, further illustrating its inherent flexibility.

A major InfoSec advantage is that any of the separate machines (of a workstation) can be configured to operate in a stand-alone mode (i.e. with zero external connections), or to operate with only internal/corporate/private resources, such as a corporate local-area-network (LAN) type resource. The physical separation feature of members of the set of separate machines of a workstation, provides a protected operational domain for the processing of internal, proprietary, or classified type information that is not for access by the ROTW.

These and additional capabilities, utility, and attainments of the present invention, should become apparent to those skilled in the art, upon reading of the following detailed description when taken in conjunction with the drawings wherein there is shown and described illustrative embodiments of the invention.

### BRIEF DESCRIPTION OF THE DRAWINGS

In the course of the following detailed description, reference will be made to the attached drawings in which:

FIG. 1 is an illustration of a prior art firewall configuration wherein a protected system is connected to an external system via an intervening firewall arrangement consisting of a gateway function processor surrounded on either side by a router function;

FIG. 2 illustrates a prior art configuration using 2 system-units/towers for a workstation;

FIG. 3 illustrates a prior art configuration to support a software method for disk access control;

FIG. 4 illustrates a 2 disk embodiment of the invention;

FIG. 5 diagrams detail of the rear panel of the invention;

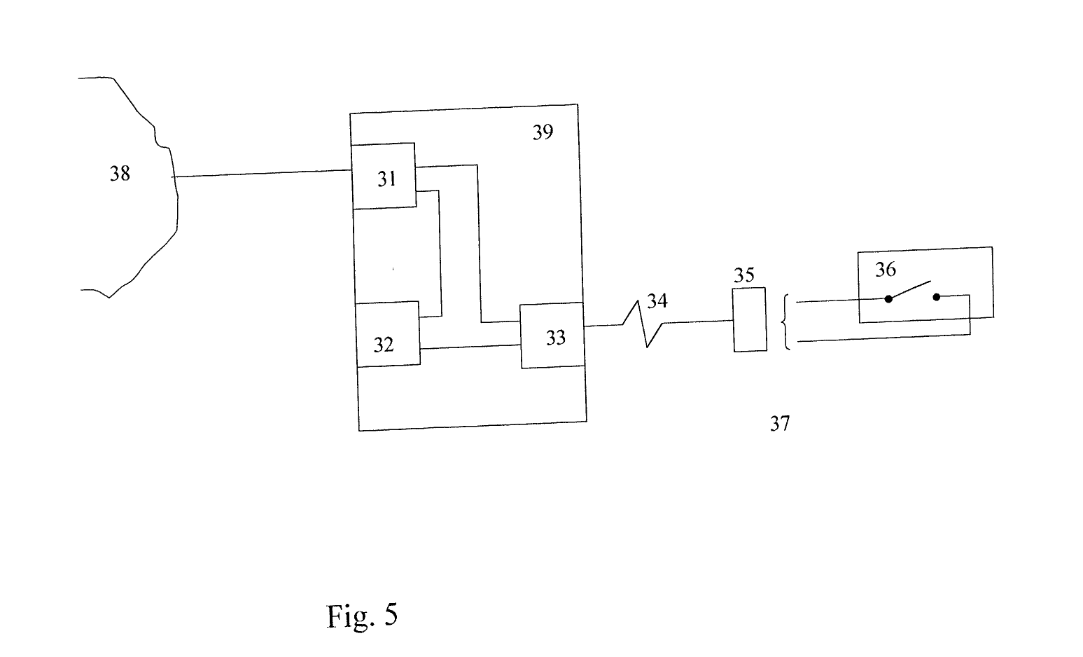

FIG. 6 illustrates detail of the front panel of the invention, with the capability to implement multiple hard-disk drive (HDD) units;

FIG. 7 illustrates a standard HDD connection;

FIG. 8 illustrates detail of a connection for multiple HDD units and embedded-computer system units.

### DETAILED DESCRIPTION OF THE INVENTION

The invention has several fundamental embodiments which are described in the following sections. Other embodiments are derived from these fundamental embodiments. The term “domain” is used throughout this document. “Domain” is defined as a system or network or set of systems or networks. The term “router” refers to a computer that selects and implements, at the software level, data-paths from one location to another in a computer network. Also the term “signal” is used synonymously with data, data sets, files, messages, packets, protocol sequences, etc. throughout this document, to stress generality. Signals, as referenced herein, refer to any information carrying quanta, such as electromagnetic current, lightwaves, which are processable by information system technology. It is fundamental to realize that data, data sets, control commands, etc., are manifested as electronic signals and/or electro-optic signals and that information systems and networks transform and tranceive such signals, and that the invention as described more fully below, operates at this fundamental signal level.

Prior Art Attempts

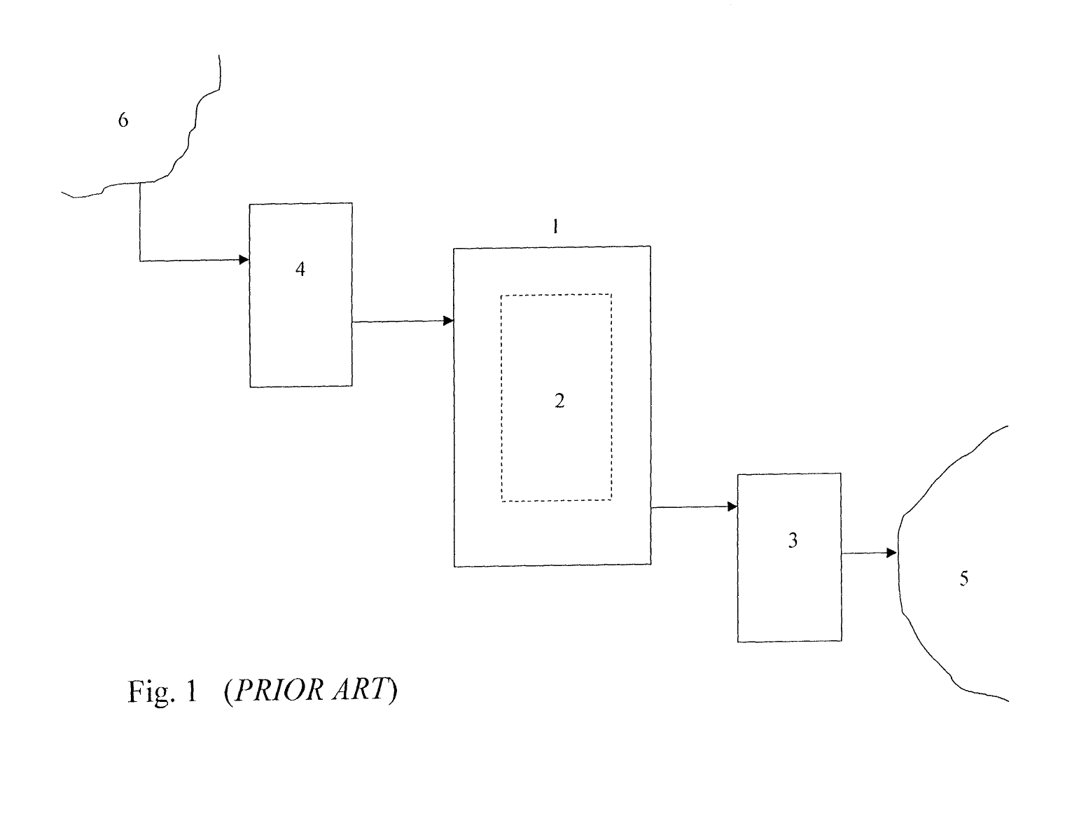

Referring to FIG. 1, there is illustrated a prior art firewall arrangement. An ordinary gateway function module 1 sits between two filtering routers 3 and 4. One router 3 is connected to an internal network 5 and the gateway 1. The other router 4 is connected to an external network 6 and the gateway. These modules and especially their software must interact in an error-free and complex fashion to enforce a security policy for information transfer between the internal network and the external network. These modules primarily implement a filtering function 2, which implies that externally generated signal traffic will enter the internal network. Such traffic may be contaminated, and thus compromise the internal network.

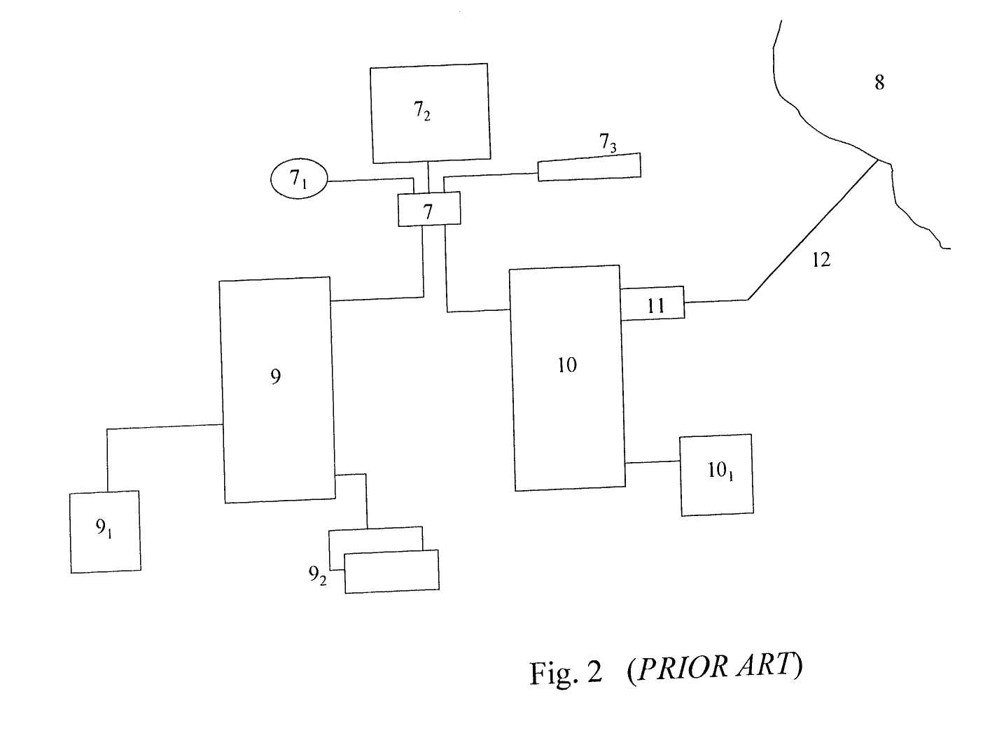

Referring to FIG. 2, an A/B switch 7, switches the mouse 7₁, monitor 7₂, and keyboard 7₃, of a personal computer (PC)/workstation, between two towers (i.e. system-units) 9, and 10, of the workstation. The tower 10, is used for external connections. This is usually accomplished via a modem type device 11, which is connected to the Public Switched Telephone Network (PSTN) & Internet 8, using a standard telephone cable 12. The internal tower 9, has no connections to the public domain. Device 10₁ is a peripheral device, such as a printer. Devices 9₁ and 9₂ are peripheral devices for the internal system 9. The user of the workstation manually switches (via the A/B switch 7) between the two towers 9 and 10. Thus, at any given time tower 9 is connected to the monitor/keyboard/mouse, or tower 10 is so connected. There is no simultaneous connection of the towers 9 and 10. Operationally, this is a form of the old “Periods Processing” operation technique begun in the 1950's by the U.S. Air Force and other gov't operators of large mainframe type computer systems. Obviously, the internal tower 9, is protected from the outside world 8, by not being externally connected. Disadvantages are size and cost. Generally, such a configuration as FIG. 2 would cost at least double that of a standard workstation.

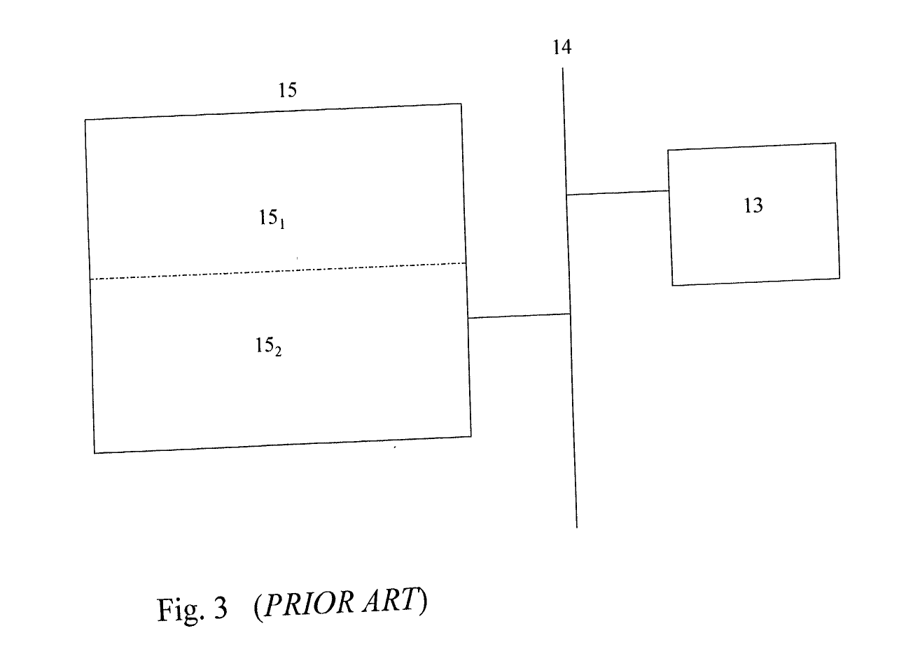

Referring to FIG. 3, a control system 13, is illustrated that “virtually” (not physically) segments a hardware mass-storage device (e.g. a hard-disk drive (HDD)) 15, into two segments 15₁ and 15₂. The device 15, and its control system 13 are connected via an expansion-bus 14, of a workstation. The controller 13 operates and maintains a separate file-allocation-table (FAT) for each segment 15₁ and 15₂. This is an extension of the operating-system software of the host workstation. If the operating-system software of the host workstation is compromised (for example, by hackers, viruses, etc.), the double FAT method is thus also compromised. This method relies on the integrity of the operating-system software of the host workstation, for proper operation of the control function for the device 15 and segments 15₁ and 15₂.

All methods in current practice are software based, and operate on a framework derivable from that depicted in FIG. 1. Generally, software cannot be “trusted” to function correctly, where “trusted” is defined to include provable correctness in structure, compilation, installation, operation. Also hacking and other types of intrusions attack the software of the networks that are targeted. A prime example is the Internet where intrusions, hacking, web-site compromise, and other forms of software misuse are rampant.

Hardware-Based InfoSec Provided by the Present Invention

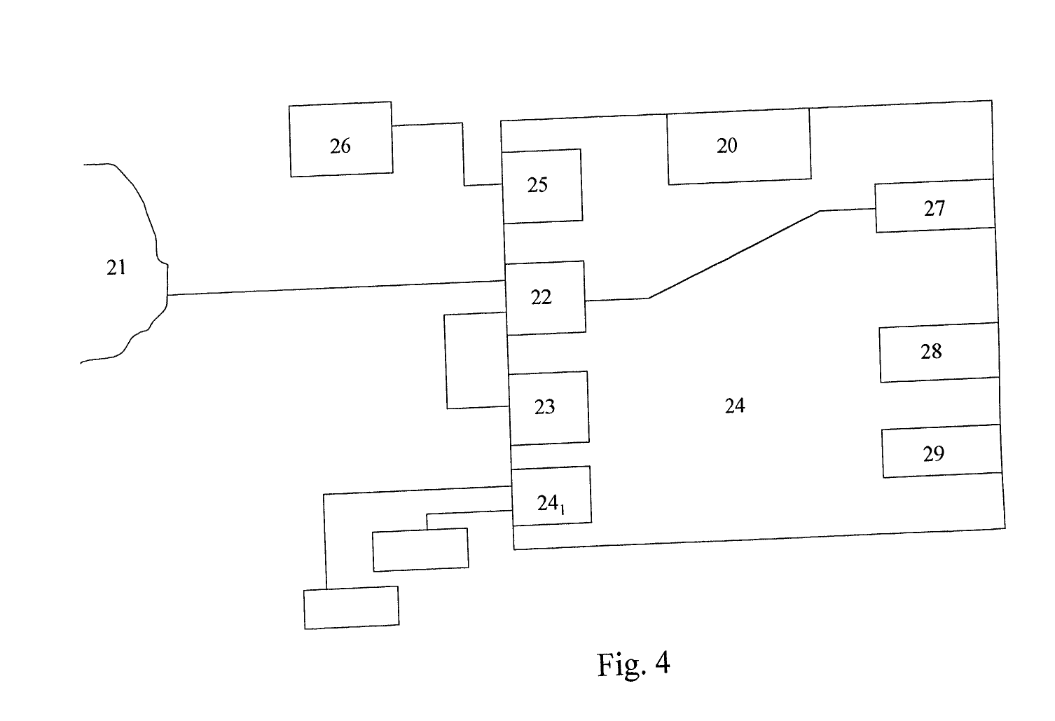

Referencing FIG. 4, a multi disk personal computer (PC) is illustrated. The workstation 24, contains two hard-disk drive (HDD) units 28 and 29. The HDD units are selectively activated by the workstation's user, via the HDD selector switch 27, on the front panel of the workstation. There is no information signal exchange between HDD 28 and HDD 29. Thus, when either HDD unit is active/connected, a physically separate workstation is defined. The invention is used to connect power 20, to one of the HDD units 8,9 at a time. In this basic embodiment of the invention, the activation/deactivation of an HDD unit is accomplished by the power switching process. HDD 8 is powered up, while HDD 9 is powered down, and the reverse. The invention can select an HDD unit by connecting it to the hardware interface (e.g. EIDE, IDE, ISA, SCSI) ports of the workstation, in other embodiments of the invention. Only one such HDD connection can exist at a time in this embodiment of the invention. The key components of the multi-HDD workstation and the invention are as follows;

20—power supply

21—ROTW (rest of the world)

22—rear control panel (communications)

23—FAX modem or NIC (network interface card)

24—PC/workstation

24₁—mouse and keyboard

25—VGA driver port

26—monitor

27—front control panel (communications and HDD unit select)

28—HDD₁

29—HDD₂

The power switching process, for the multiple HDD unit, is the most fundamental embodiment of the invention, and was thus illustrated here.

Referencing FIG. 57 detail of the rear control panel of the invention is illustrated. The workstation user can activate or break the communication link of the workstation. This is useful in insuring that no hostile external signals impact the workstation while an HDD unit selection process is underway. The components of the rear panel subsystem are as follows;

31—modem/phone or NIC (network interface card) female connector

32—modem/phone or NIC female connector

33—modem/phone or NIC female connector

34—modem/phone or NIC cable

35—modem/phone or NIC female connector

36—external-connection make/break switch (under user control)

37—front panel area

38—ROTW

39—expansion-bus card

The expansion-bus card 39, can be minimal in size, for space saving.

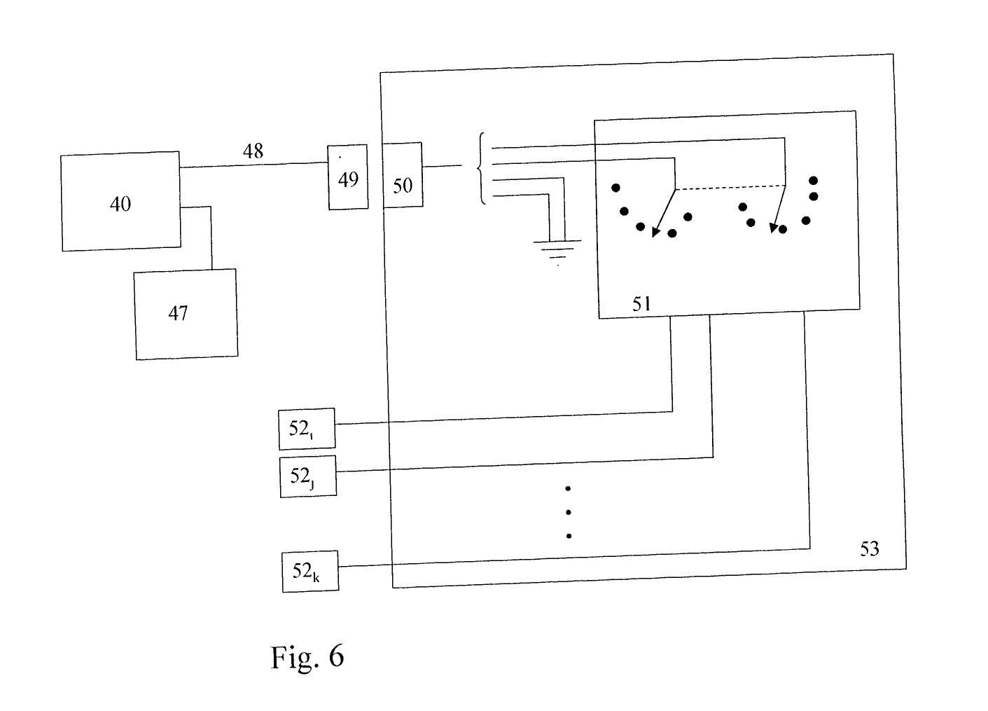

Referencing FIG. 6, details of the front panel of the invention are illustrated. The use of greater than two HDD units is shown, to further illuminate the flexibility and scaling capability of the invention. The components of the front panel control are as follows;

40—power supply

47—other components of workstation

48—HDD cable (4 wire)

49—standard female connector

50—standard male connector

51—OR mechanical switch (n positions)

52_{(i to n)}—power-connectors to n mass-storage devices

53—front panel

It is noted here that another set of controls could be added to the front panel, for the advanced user. The jumper settings for the HDD devices could be made accessible from a set of switches on an embodiment of the front panel. Also, an HDD device can be replaced by a daisy-chain type arrangement of mass-storage devices (e.g. a master/slave configuration) forming a higher capacity unit. The HDD units can be replaced by other mass-storage devices, such as CD-R/W devices. Additionally, the mass-storage devices can be replaced by single-board-computers, embedded-computers, and like systems. Such upgrades to the invention will significantly enhance the utility, reliability, and InfoSec capability of the host workstation.

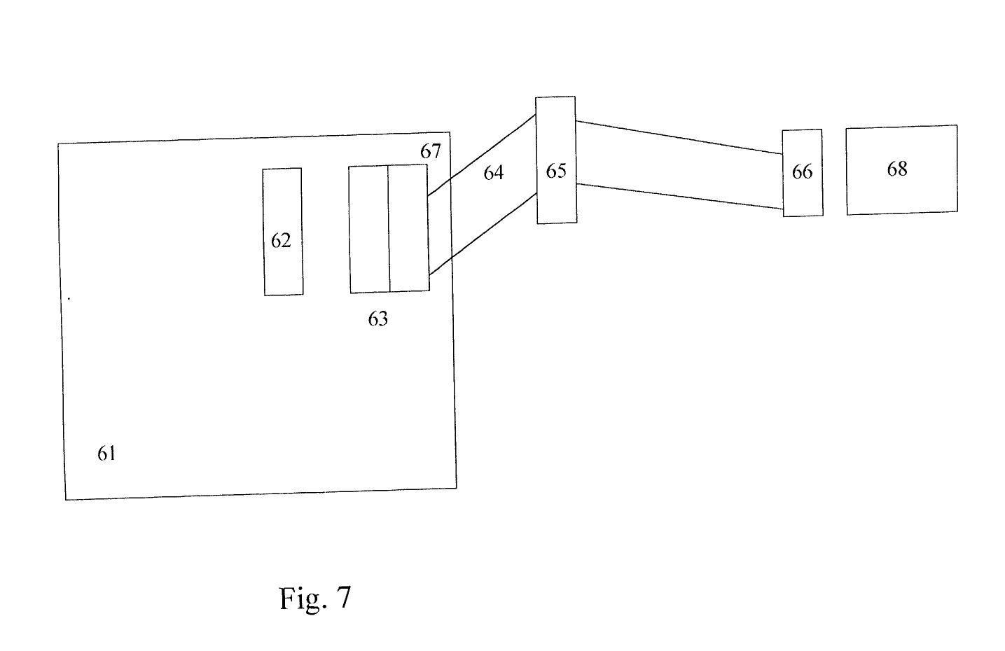

Referencing FIG. 7, a normal connection configuration of HDD signal cables is illustrated. The key components are as follows;

61—motherboard of host workstation

62—primary IDE connector

63—secondary IDE connector

64—ribbon cable

65—interline-connector (for additional device or another cable)

66—end-connector to mass-storage device

67—end-connector to motherboard

68—HDD device

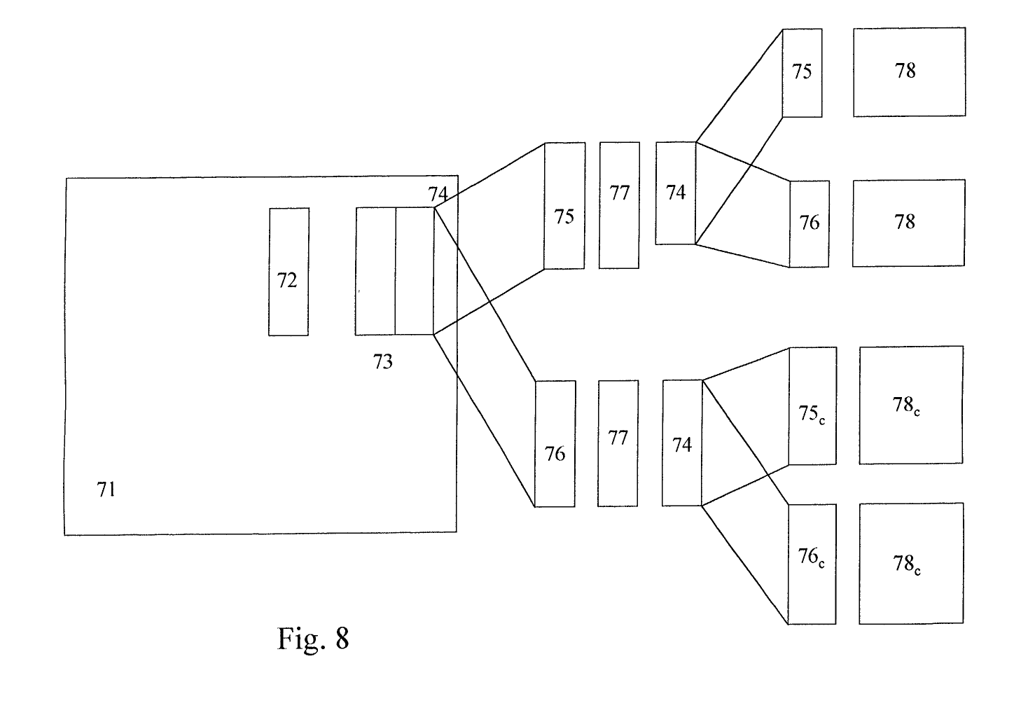

Referencing FIG. 8, an example embodiment of the invention with several HDD units, is illustrated. The key components are as follows;

71—motherboard of host workstation

72—primary IDE connector

73—secondary IDE connector

74—end-connector to motherboard

75—end-connector to mass-storage device

75_{c}—end-connector to Computer-System Structured Mass-Storage Unit

76—end-connector to mass-storage device

76_{c}—end-connector to Computer-System Structured Mass-Storage Unit

77—ribbon cable male/male adapter

78—HDD device

78_{c}—Computer-System Structured Mass-Storage Unit

It is important to note that as active HDD units are deactivated, they can be reset (i.e. their original or pre-activation contents restored) via a disk-copy type process with base-HDD units. These base-HDD units contain the original contents of the operational HDD units. Depending on the specific application, the base-HDD units may contain the contents from the operational HDD unit's previous activation. The base-HDD units are not available for selection to form separate machines of the host workstation. Generically, all HDD units are considered operational units unless specifically designated as base-HDD units.

At this juncture, it is appropriate to introduce the primary ramifications when the HDD units are replaced with embedded computer systems, single-board-computer systems, or like devices. These devices provide the mass-storage function required of the basic embodiment of the invention. Additionally, they are full computer systems. As such they greatly expand the range and utility of the invention. The following discussion presents the generic utility of embodiments of the invention which utilize embedded system techniques and technology.

Mass-storage units that are replaced by embedded computer type devices are referred to herein as computer-system-structured mass-storage units (78_{c}). The embedded computer systems generically conform to the PC/104 standard for embedded computers, or the PC/104-+ standard for PCI (Peripheral Component Interconnect) bus compatible embedded computers.

The computer-system-structured mass-storage units provide a complete computer system (instead of just a mass-storage device) to the set of separate machines of a workstation. This greatly increases the flexibility, processing power, functionality, and reliability of the workstation. The reliability enhancement is manifested in both InfoSec and operations for the workstation. As an InfoSec example, a given separate machine (of the workstation) confines errors and external contaminates (e.g. viruses) within that separate machine. A reset function (initiated on deactivation of the separate machine) purges any contamination and restores the separate machine to its original state. As an operational example, one separate machine can be used to access a resource (e.g. an instant-messaging resource). Another separate machine can be used to access another resource that is incompatible with the first resource. Thus, the workstation injects a degree of interoperability between incompatible resources (e.g. instant-messaging application packages), permitting the user of the workstation to use either resource. This provides an interoperation capability between incompatible resources, without having to alter those resources. The necessity for porting resources is eliminated. An important distinction is that the resources themselves are not interoperable, but the use of such resources (by a user of the invention) is permitted. The invention provides the user an operational bridge between the incompatible resources. This is a form of “virtual interoperability”. Herein “virtual interoperability” is defined as the capability to access and operate with incompatible resources, wherein such access is not generally simultaneous.

It is important to note that both standard mass-storage devices 78, and computer-system-structured mass-storage units 78_{c}, can be available in various embodiments of the invention. This is an additional flexibility factor inherent in the invention. Also, separate machines (of the workstation) formed by these units can be used for handling internal (e.g. secret, top-secret, proprietary, etc.) information. Such separate machines would have configurations that disable external (to the workstation) connections. They would operate in a stand-alone operational mode. Additionally, some of such separate machines can be configured for only internal connections (e.g. to an internal corporate network). These separate machines can be viewed as a protected subset of the set of separate machines of a workstation.

Further, when the mass-storage units are structured as complete computer systems, the individual members of the set of separate machines of a workstation can be interconnected to form computing clusters. Such clusters are treated as a single separate machine, in that no information signal exchange with separate machines not in the cluster, is permitted. Such clusters can be pre-wired or formed dynamically under the separate machine selection process. Additionally, members of a cluster may be interconnected in conventional bus type architectures or in non-conventional architectures (such as neural networks) that permit activation/deactivation control of individual interconnections, by the interconnected separate machines themselves. Such control can be accomplished using (algorithmic or analog) neural network type techniques and/or the separate machine selection process. The employment of such clusters provides additional processing capability and additional functionality to the host workstation.

Highspeed, multimedia processing environments may require such processing and functional enhancements for workstations. An example requirement is maintaining quality-of-service (QoS) under an intensive video-streaming application. A workstation can address this requirement by employing a “virtual streaming” technique to receive the incoming data stream. Data streaming is defined as continuous transmission of data. Virtual Streaming is a technique (herein defined) for recovering data streams that is made practical, by computing clusters of the computer-system-structured mass-storage units (78_{c}), of a workstation. Virtual Streaming is defined as the use of fast buffering techniques and interleaving, to provide a store-processing-and forward function for data units incoming to a system. The processing step insures data unit integrity and proper sequencing, and enhances the QoS of the incoming data stream. The speed of the “virtual streaming” function is sufficiently fast such that the incoming data stream appears (to the receiver) as a normal data stream.

Again referring to FIG. 8, the computer-system-structured mass-storage units (78_{c}), of a workstation, can host separate software operating systems (e.g. Windows, Linux, etc.). Each computer-system-structured mass-storage unit (78_{c}), of a workstation, defines a physically separated machine, for that workstation. Therefore, each computer-system-structured mass-storage unit (78_{c}), of a workstation, defines a separate domain of operation for its software operating system. This factor does not preclude such mass-storage units from having identical operating system software. This factor adds another degree of flexibility to the invention, and thus to the host workstation. This domain confinement, of an operating system software package, provides a Fault-Tolerant capability element to the workstation. Any faults, incompatibilities, compromises, or other peculiarities of a given operating system software package, are confined within its separate machine, of the workstation. The host workstation is thus enhanced in processing power, flexibility, utility, and reliability by the invention.

It is expected that the present invention and many of its attendant advantages will be understood from the forgoing description and it will be apparent that various changes may be made in form, implementation, and arrangement of the components, systems, and subsystems thereof without departing from the spirit and scope of the invention or sacrificing all of its material advantages, the forms hereinbefore described being merely preferred or exemplary embodiments thereof.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims and their equivalents.

1. A method for dividing a workstation into a set of separate machines such that each member of the set of separate machines is autonomous, activated separately in time (i.e. not simultaneously active with other members of the set of separate machines), and does not exchange information with other members of the set of separate machines, wherein any member of the set of separate machines can be connected to external information systems and resources without contamination (from signals from such external systems and resources) of other members of the set of separate machines, comprising the steps of:
a. connecting a separate mass-storage device (for each separate machine) to the workstation, wherein said separate mass-storage device contains the configuration and boot/start-up commands specific to its particular separate machine;
b. inserting a mass-storage device selector into the workstation, such that said selector function activates a subset of mass-storage devices connected to the workstation and deactivates mass-storage devices (connected to the workstation) not in the subset of activated mass-storage devices;
c. configuring the mass-storage device selector to initiate a workstation boot/start-up sequence as a stage of each mass-storage device selection sequence, wherein the boot/start-up sequence is a workstation reset function which prevents any information exchange between members of the set of separate machines;
d. disabling any external connectivity of the workstation during a mass-storage device selection sequence, such that no hostile external information signals impact the workstation during said selection sequence;
e. restoring deactivated mass-storage devices to an initial non-contaminated state;

2. The method of claim 1, wherein the step of connecting includes external (to the workstation) and internal (to the workstation) mass-storage devices, whereby such mass-storage devices range from standard hard-disk drive (HDD) units to removable media devices such as tape drives, ZIP drives, CD-R drives, CD-R/W drives, writeable DVD drives, and like devices;

3. The method of claim 1, wherein the step of inserting and the step of configuring includes the implementation of an optional access control function (e.g. lock & key) for the mass-storage device selector, thus enabling the capability to restrict certain users (of a workstation) to specific members of the set of separate machines, of a multiple user workstation, thereby forcing a degree of privacy protection for the multiple users of said workstation;

4. The method of claim 2, wherein a mass-storage device is treated as a logical mass-storage unit and can include a multiplicity of mass-storage devices connected in such manner as to operate as a single mass-storage unit (e.g. a master-slave configuration), defining a single member of the set of separate machines of a workstation;

5. A system for dividing a workstation into a set of separate machines such that each member of the set of separate machines is autonomous, activated separately in time (i.e. not simultaneously active with other members of the set of separate machines), and does not exchange information with other members of the set of separate machines, wherein any member of the set of separate machines can be connected to external information systems and resources (such as the Internet) without contamination (from signals from such external systems and resources) of other members of the set of separate machines, comprising:
a. a means for connecting a separate mass-storage unit (for each separate machine) to the workstation, wherein said separate mass-storage unit contains the configuration and boot/start-up commands specific to its particular separate machine;
b. a means for selecting separate mass-storage units connected to the workstation, such that said means for selecting activates a subset of mass-storage units connected to the workstation and deactivates mass-storage units (connected to the workstation) not in the subset of activated mass-storage units;
c. a means for initiating a workstation boot/start-up sequence as a stage of each mass-storage unit selection sequence, such that the boot/start-up sequence is a workstation reset function which prevents any information exchange between members of the set of separate machines;
d. a means to disable external connectivity of the workstation during a mass-storage unit selection sequence, such that no hostile external information signals impact the workstation during said selection sequence;
e. a means for restoring deactivated mass-storage units to an initial non-contaminated state;

6. The system of claim 5, wherein a mass-storage unit defining a member of the set of separate machines of a workstation, is comprised of a multiplicity of mass-storage devices connected in such manner as to operate as a single mass-storage unit, whereby the multiplicity is comprised of mass-storage devices that range from standard hard-disk drive (HDD) units to removable media devices such as tape drives, ZIP drives, CD-R drives, CD-R/W drives, writeable DVD drives, and like devices;

7. The system of claim 5, wherein the means for selecting implements an exclusive-OR (i.e. XOR) type process, such that at most one member of the set of separate machines (of the workstation) is active at any time;

8. The system of claim 5, wherein the means for initiating is an automatic step of the mass-storage unit selection process;

9. The system of claim 5, wherein the means for restoring is a user-optional, application-specific, function which generically involves a disk-copy type process, such that the deactivated mass-storage unit receives an image/copy of the contents of a base mass-storage unit connected to the workstation;

10. The system of claim 9, wherein a base mass-storage unit is defined at operational initiation of the workstation and is a member of the set of separate machines (of the workstation) which is available only for the mass-storage unit restoration process, and is not available for selection as the component of an operational separate machine;

11. The system of claim 10, wherein a multiplicity of base mass-storage units is defined;

12. The system of claim 5, wherein the means for connecting includes the means for connecting a multiplicity of mass-storage units, each of which is structured as a full computer system (such as an embedded computer type device, a single board computer type device, or like devices), in such manner that each of the separate machines operates as an autonomous embedded unit to the host workstation, wherein each embedded unit has the functionality of a complete computer system of its type (e.g. single board computers, PC/104 type embedded computers, PC/104-+ type embedded computers), in addition to its mass-storage unit function;

13. The system of claim 12, wherein each member of the set of computer-system-structured mass-storage units has the capability to be reset by the selection process of claim 5, at the time of its selection, whereby the initiation (including automatic initiation) of an actual reset function is an application specific determination by users of the workstation;

14. The system of claim 12, wherein each computer-system-structured mass-storage unit is configured in such manner that its separate machine interfaces with a different external resource, wherein each of said external resources is classified (e.g. Top Secret, Confidential, Proprietary, project-λ, etc.), thus implementing a CMWS (Compartmented Mode WorkStation) capability; for the workstation;

15. The system of claim 14, wherein each computer-system-structured mass-storage unit has the capacity to filter outgoing information signals from its separate machine, thereby preventing unauthorized release of information;

16. The system of claim 5, wherein each separate machine is physically separated from all other separate machines connected to the workstation, thus further reducing the probability of information exchange between the separate machines connected to the workstation, wherein such physical separation is a property of the architecture of the invention;

17. The system of claim 12, wherein members of the set of computer-system-structured mass-storage units are independently configured to perform functions such as floating-point computation, pattern matching, virtual streaming, and like advanced functions either computationally-based or non-computationally-based (e.g. dynamic pattern matching/classification functions), such that the selection/activation of said units enables computing clusters, thus providing adaptive advanced functionality to the workstation;

18. The system of claim 16, wherein each physically-separated separate machine defined by a computer-system-structured mass-storage unit, hosts its own software operating-system (such as Windows, Linux, or like software operating-systems), thus creating and maintaining a separate isolated domain for said operating-system, whereby a particular software operating-system hosted by a member of the set of separate machines of a workstation may be identical to that operating-system hosted by another member of the set of separate machines of said workstation, without exchange of information signals between such members of the set of separate machines of the workstation;

19. The system of claim 18, wherein the confinement of a specific operating-system (such as Windows, Linux, etc.) to a particular separate machine of the host workstation, also confines any peculiarities, errors, incompatibilities, contamination, and such deficiencies (of an operating-system), to that particular separate machine, thereby adding an element of Fault-Tolerance to the host workstation;

20. The system of claim 19, wherein the use of the separate machines provides the users of the host workstation an operational bridge between incompatible external (to the workstation) resources, wherein this operational bridge provides a “virtual interoperability” capability between incompatible external resources, whereby such external resources can include various incompatible “instant messaging” type systems, providing relief to the problem of incompatibility of such external resources;

21. The system of claim 20, wherein a subset of the set of separate machines of a workstation are configured to store and process internal (e.g. classified, proprietary, etc.) information, wherein such configuration restricts connectivity (of members of this subset of separate machines) to corporate local-area-network (LAN) type resources or other like internal/private resources, thereby defining a subset of protected separate machines;

22. The system of claim 21, wherein a subset of the set of separate machines of a workstation are configured to store and process internal (e.g. classified, proprietary, etc.) information, wherein such configuration restricts connectivity (of members of this subset of separate machines) to operate in a stand-alone mode (i.e. zero external, to the workstation, connectivity), thereby defining a subset of standalone, protected separate machines, whereby a stand-alone operational mode is generically the most secure from external contamination and hacker type attack.
